(19) United States
(12) Patent Application Publication
(10) Pub. No.: US 2026/0012105 A1
(43) Pub. Date: Jan. 8, 2026

(54) Grid-connected inverter control method and grid-connected inverter

(71) Applicant: SHENZHEN POWEROAK NEWENER CO.,LTD, Shenzhen (CN)

(72) Inventors: Wentao Cang, Shenzhen (CN); Jianhua Lei, Shenzhen (CN); Hui Ma, Shenzhen (CN); Geng Qin, Shenzhen (CN); Zhihua Guo, Shenzhen (CN); Chuantong Hao, Shenzhen (CN)

(21) Appl. No.: 19/249,827

(22) Filed: Jun. 25, 2025

(30) Foreign Application Priority Data
Jul. 4, 2024 (CN) 202410889341.2

(51) Int. Cl. H02M 7/5387; H02M 1/00

(52) U.S. Cl. CPC H02M 7/53871; H02M 1/0058

(57) ABSTRACT

A grid-connected inverter control method comprises: determining a calculation rule of the switching period meeting the zero-voltage switching condition and a mapping relationship between the capacitance value of the output capacitor and a voltage difference between a DC input voltage and a grid voltage; according to the polarity of the grid-connected reference current, determining the switching transistor operating at high frequency; according to the grid-connected current and the grid-connected reference current, determining the duty ratio; calculating the switching period according to the calculation rule of the switching period, the mapping relationship, the DC input voltage, the grid voltage, the grid-connected reference current and the duty ratio; and controlling the zero-voltage switching of the switching transistor according to the switching period and the duty ratio.

### CROSS-REFERENCE TO RELATED APPLICATIONS

The present application claims the benefit of and priority to Chinese Patent Application NO. 202410889341.2, filed with the Chinese Patent Office on Jul. 4, 2024, titled “Grid-connected inverter control method and grid-connected inverter”, which is hereby incorporated by reference in its entirety.

### TECHNICAL FIELD OF THE INVENTION

The present application relates to the technical field of micro-grids, and in particular, relates to a grid-connected invert control method and a grid-connected inverter.

### BACKGROUND OF THE INVENTION

Grid-connected inverters are widely used in the technical field of micro-grids, and common grid-connected inverters are composed of four switching transistors and a filter circuit. By controlling the high-frequency switching operation of the switching transistors, high-frequency current is generated, which is then converted into utility-frequency alternating current via the filter circuit before being fed into the grid. However, the conventional hard-switching control method will result in a significant turn-on loss of the switching transistor, which is not conducive to the development of grid-connected inverters towards high frequency and high efficiency.

### SUMMARY OF THE INVENTION

According to an aspect of the present application, a grid-connected inverter control method is provided, the grid-connected inverter comprises a DC voltage input source, switching transistors S₁ to S₄, and body diodes D₁ to D₄ and output capacitors C₁ to C₄ connected in parallel with the switching transistors, a filter inductor L₁ and a filter capacitor Cₒ₂ connected to the bridge arm where the switching transistor S₁/S₂ is located, a filter inductor L₂ and a filter capacitor Cₒ₁ connected to the bridge arm where the switching transistor S₃/S₄ is located, and a grid Grid, and the method comprises:
Step A, based on the waveform data of an output capacitor voltage across a switching transistor operating at high frequency and the corresponding filter inductor current, determining a calculation rule of the switching period Tₛ meeting the zero-voltage switching condition and the mapping relationship between the capacitance value of the output capacitor and the voltage difference between a DC input voltage and a grid voltage;
Step B, acquiring the DC input voltage, the grid voltage, a grid-connected current and a grid-connected reference current;
Step C, according to the polarity of the grid-connected reference current, determining the switching transistor operating at high frequency;
Step D, according to the grid-connected current and the grid-connected reference current, determining the duty ratio based on a closed-loop regulation mechanism;
Step E, calculating the switching period Tₛ according to the calculation rule of the switching period Tₛ, the mapping relationship, the DC input voltage, the grid voltage, the grid-connected reference current and the duty ratio; and
Step F, controlling the zero-voltage switching of the switching transistor according to the switching period Tₛ and the duty ratio.

Optionally, the Step A comprises:
based on a set of waveform data of the output capacitor voltage across the switching transistor operating at high frequency and the corresponding filter inductor current in a switching period, determining the start/end time point of the switching period Tₛ meeting the zero-voltage switching condition;
according to the start/end time point of the switching period Tₛ, determining each of stages included in the switching period Tₛ and the calculation rule of each of the stages; and
obtaining the calculation rule of the switching period Tₛ according to the calculation rule of each of the stages.

Optionally, the start/end time point of the switching period Tₛ meeting the zero-voltage switching condition is the time point when the filter inductor current and the output capacitor voltage are both zero in the set of waveform data.

Optionally, the switching period Tₛ comprises a switching transistor on-stage Tₒₙ, an output capacitor charging stage T₁, a switching transistor off-stage T_{off}, a first resonance stage T₂, a body diode clamping stage T₃ and several second resonance stages T₄.

Optionally, the calculation rule of the switching period Tₛ is:

$$\{ \begin{matrix}{T}_{s} & = {T}_{on} + {T}_{off} + {T}_{1} + {T}_{2} + {T}_{3} + {nT}_{4} \\ {T}_{on} & = \frac{2 {Li}_{p}}{{V}_{in} - \vert {V}_{grid} \vert} \\ {T}_{off} & = \frac{2 {Li}_{p}}{{V}_{in} + \vert {V}_{grid} \vert} \\ {T}_{1} & = \frac{2 LC}{2 \vert {i}_{ref} \vert + \sqrt{\frac{C}{2 L} ( {V}_{in} + \vert {V}_{grid} \vert )}} \\ {T}_{2} & = \sqrt{2 LC} arccos ( \frac{\vert {V}_{grid} \vert - {V}_{in}}{\vert {V}_{grid} \vert + {V}_{in}} ) \\ {T}_{3} & = \sqrt{2 LC} ( \frac{{V}_{in} + \vert {V}_{grid} \vert}{{V}_{in} - \vert {V}_{grid} \vert} ) sin ( \frac{{T}_{2}}{\sqrt{2 LC}} ) \\ {T}_{4} & = 2 π \sqrt{2 LC}\end{matrix}$$

wherein, n is the adjustment value of the switching period Tₛ and is an integer greater than or equal to zero, L is the inductance value of the filter inductor,

$${i}_{p} = \frac{duty \times ( {T}_{1} + {T}_{2} + {T}_{3} + {nT}_{4} ) ( {V}_{in}^{2} - {V}_{grid}^{2} )}{2 L ( {V}_{in} + \vert {V}_{grid} \vert - 2 duty {V}_{in} )} ,$$

iₚ is the peak value of the filter inductor current, duty is the duty ratio, Vᵢₙ is the DC input voltage, V_{grid} is the grid voltage, i_{ref} is the grid-connected reference current, and C is the capacitance value of the output capacitor, which has a mapping relationship expressed as C=f₃(Vᵢₙ−V_{grid}) with the voltage difference Vᵢₙ−V_{grid}.

Optionally, the Step A further comprises:
based on multiple sets of waveform data of the output capacitor voltage across the switching transistor operating at high frequency and the corresponding filter inductor current in different switching periods, measuring T₄ under conditions of different DC input voltages Vᵢₙ and different grid voltages V_{grid}, and calculating the capacitance value C of the corresponding output capacitor according to the measured T₄;
by taking the difference (Vᵢₙ−V_{grid}) between the different DC input voltages Vᵢₙ and the different grid voltages V_{grid} as input and taking the capacitance value C of the output capacitor calculated according to the different DC input voltages Vᵢₙ and the different grid voltages V_{grid} as output, obtaining the mapping relationship C=f₃(Vᵢₙ−V_{grid}) between the capacitance value C of the output capacitor and the voltage difference between the DC input voltage Vᵢₙ and the grid voltage V_{grid} by polynomial fitting.

Optionally, the Step D comprises:
according to the grid-connected current i_{grid} and the grid-connected reference current i_{ref}, calculating the duty ratio duty based on the following equation:

$$duty = {G}_{P} ( {i}_{ref} - {i}_{grid} )$$

wherein G_{P} is the transfer function of a closed-loop controller.

According to another aspect of the present application, a grid-connected inverter is provided, the grid-connected inverter comprises a DC voltage input source, switching transistors S₁ to S₄, and body diodes D₁ to D₄ and output capacitors C₁ to C₄ connected in parallel with the switching transistors, a filter inductor L₁ and a filter capacitor Cₒ₂ connected to the bridge arm where the switching transistor S₁/S₂ is located, a filter inductor L₂ and a filter capacitor Cₒ₁ connected to the bridge arm where the switching transistor S₃/S₄ is located, a grid Grid, and a controller, wherein the calculation rule of the switching period Tₛ meeting the zero-voltage switching condition and the mapping relationship between the capacitance value of the output capacitor and the voltage difference between the DC input voltage and the grid voltage are preset in the controller,
the controller is configured to acquire the DC input voltage, the grid voltage, a grid-connected current and a grid-connected reference current; determine the switching transistor operating at high frequency according to the polarity of the grid-connected reference current; determine the duty ratio based on a closed-loop regulation mechanism according to the grid-connected current and the grid-connected reference current; determine the switching period Tₛ according to the calculation rule of the switching period Tₛ, the mapping relationship, the DC input voltage, the grid voltage, the grid-connected reference current and the duty ratio; and control the zero-voltage switching of the switching transistor according to the switching period Tₛ and the duty ratio.

Optionally, the calculation rule of the switching period Tₛ is:

$$\{ \begin{matrix}{T}_{s} & = {T}_{on} + {T}_{off} + {T}_{1} + {T}_{2} + {T}_{3} + {nT}_{4} \\ {T}_{on} & = \frac{2 {Li}_{p}}{{V}_{in} - \vert {V}_{grid} \vert} \\ {T}_{off} & = \frac{2 {Li}_{p}}{{V}_{in} + \vert {V}_{grid} \vert} \\ {T}_{1} & = \frac{2 LC}{2 \vert {i}_{ref} \vert + \sqrt{\frac{C}{2 L} ( {V}_{in} + \vert {V}_{grid} \vert )}} \\ {T}_{2} & = \sqrt{2 LC} arccos ( \frac{\vert {V}_{grid} \vert - {V}_{in}}{\vert {V}_{grid} \vert + {V}_{in}} ) \\ {T}_{3} & = \sqrt{2 LC} ( \frac{{V}_{in} + \vert {V}_{grid} \vert}{{V}_{in} - \vert {V}_{grid} \vert} ) sin ( \frac{{T}_{2}}{\sqrt{2 LC}} ) \\ {T}_{4} & = 2 π \sqrt{2 LC}\end{matrix}$$

wherein, n is the adjustment value of the switching period Tₛ and is an integer greater than or equal to zero, L is the inductance value of the filter inductor,

$${i}_{p} = \frac{duty \times ( {T}_{1} + {T}_{2} + {T}_{3} + {nT}_{4} ) ( {V}_{in}^{2} - {V}_{grid}^{2} )}{2 L ( {V}_{in} + \vert {V}_{grid} \vert - 2 duty {V}_{in} )} ,$$

iₚ is the peak value of the filter inductor current, duty is the duty ratio, Vᵢₙ is the DC input voltage, V_{grid} is the grid voltage, i_{ref} is the grid-connected reference current, and C is the capacitance value of the output capacitor, which has a mapping relationship expressed as C=f₃(Vᵢₙ−V_{grid}) with the voltage difference Vᵢₙ−V_{grid}.

Optionally, the mapping relationship is determined based on the following method:
based on multiple sets of waveform data of the output capacitor voltage across the switching transistor operating at high frequency and the corresponding filter inductor current in different switching periods, measuring T₄ under conditions of different DC input voltages Vᵢₙ and different grid voltages V_{grid}, and calculating the capacitance value C of the corresponding output capacitor according to the measured T₄; and
by taking the difference (Vᵢₙ−V_{grid}) between the different DC input voltages Vᵢₙ and the different grid voltages V_{grid} as input and taking the capacitance value C of the output capacitor calculated according to the different DC input voltages Vᵢₙ and the different grid voltages V_{grid} as output, obtaining the mapping relationship C=f₃(Vᵢₙ−V_{grid}) between the capacitance value C of the output capacitor and the voltage difference between the DC input voltage Vᵢₙ and the grid voltage V_{grid} by polynomial fitting.

### BRIEF DESCRIPTION OF DRAWINGS

One or more embodiments are exemplarily described with reference to pictures in corresponding attached drawings, and these exemplary descriptions are not intended to limit the embodiments. In the attached drawings, elements with the same reference numerals represent the same or similar elements, and unless otherwise stated, the pictures in the attached drawings are not intended to limit the scale.

FIG. 1 is a flowchart diagram of a grid-connected inverter control method provided according to an embodiment of the present application.

FIG. 2 is a schematic view of the topological structure of a grid-connected inverter provided according to an embodiment of the present application.

FIG. 3 is a schematic view of PWM driving signals of various switching transistors of the grid-connected inverter in FIG. 2.

FIG. 4 is a schematic view of the waveforms of the switching transistor S₁/S₄ driving, the output capacitor voltage V_{C1}/V_{C4} and the filter inductor current i_{L} for the grid voltage V_{grid} of the grid-connected inverter in FIG. 2 in a positive utility-frequency half-cycle.

FIG. 5 is a simulation result diagram of grid-connected current using the grid-connected inverter control method of FIG. 1.

FIG. 6 is a simulation control effect diagram using the grid-connected inverter control method of FIG. 1.

FIG. 7 is a schematic structural diagram of a grid-connected inverter provided according to an embodiment of the present application.

### DETAILED DESCRIPTION OF THE INVENTION

To make the objectives, technical solutions and advantages of embodiments of the present application more apparent, the technical solutions of the embodiments of this application will be described clearly and completely with reference to the attached drawings illustrating the embodiments of this application. Obviously, the embodiments described herein are only a part of but not all of the embodiments of this application. All other embodiments that can be obtained by those of ordinary skill in the art from the embodiments of this application without making creative efforts shall fall within the scope of this application.

In addition, the technical features involved in various embodiments of the present application described below can be combined with each other as long as they do not conflict with each other.

It shall be noted that, the steps shown in the flowchart diagrams of the accompanying drawings may be executed in a computer system such as a set of computer-executable instructions, and although logical orders are shown in the flowchart diagrams, in some cases, the steps shown or described may be executed in a different order from those described here.

### Embodiment 1

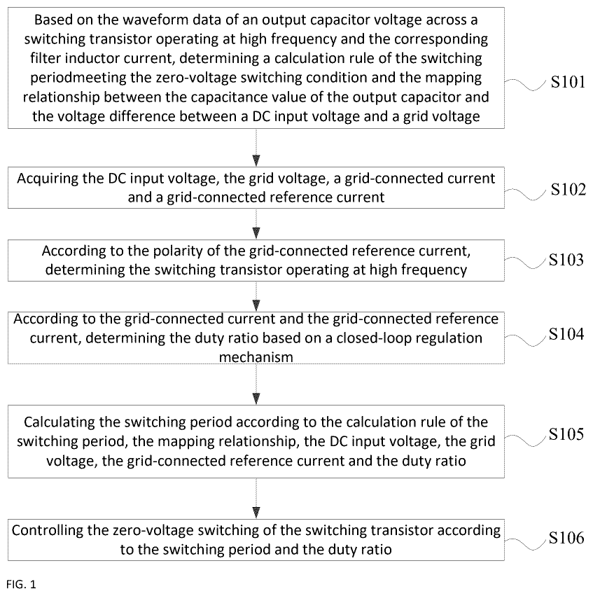

Referring to FIG. 1, there is shown a flowchart diagram of a grid-connected inverter control method provided according to an embodiment of the present application, and the method specifically includes the following steps:

Step S101: based on the waveform data of an output capacitor voltage across a switching transistor operating at high frequency and the corresponding filter inductor current, determining a calculation rule of the switching period Tₛ meeting the zero-voltage switching condition and the mapping relationship between the capacitance value of the output capacitor and the voltage difference between the DC input voltage and the grid voltage.

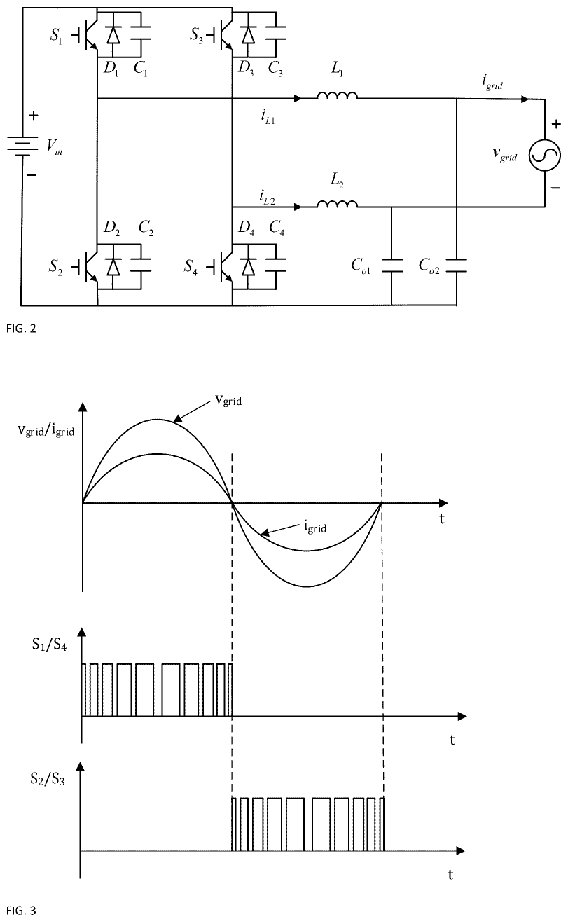

In the embodiment of the present application, the network topological structure of the grid-connected inverter is as shown in FIG. 2. The grid-connected inverter comprises a DC voltage input source, switching transistors S₁ to S₄, and body diodes D₁ to D₄ and output capacitors C₁ to C₄ connected in parallel with the switching transistors S₁ to S₄, a filter inductor L₁ and a filter capacitor Cₒ₂ connected to the bridge arm where the switching transistor S₁/S₂ is located, a filter inductor L₂ and a filter capacitor Cₒ₁ connected to the bridge arm where the switching transistor S₃/S₄ is located, and a grid Grid. In order to keep the topological symmetry, models of the filter inductors L₁ and L₂ are the same, and models of the output capacitors C₁ to C₄ are the same. That is, L₁=L₂=L, and C₁=C₂=C₃=C₄=C. L is the inductance value of the filter inductor, and C is the capacitance value of the output capacitor.

Referring to FIG. 3, there is shown a schematic view of PWM driving signals of various switching transistors of the grid-connected inverter in FIG. 2, in which phase angles of the grid voltage V_{grid} and the grid-connected current i_{grid} are the same. In the positive utility-frequency half-cycle of the grid voltage V_{grid}, the grid-connected reference current is positive, the pulse width of the high-frequency pulse width modulation (PWM) driving signal of the switching transistors S₁/S₄ changes according to the sinusoidal pattern, and the switching transistors S₁/S₄ are driven consistently, while the switching transistors S₂/S₃ remain turned off. At this time, the current flows from the positive pole of the DC voltage input source to the positive pole of the grid Grid through the switching transistor S₁ and the filter inductor L₁, and then returns to the negative pole of the DC voltage input source through the negative pole of the grid Grid, the filter inductor L₂ and the switching transistor S₄. In the negative utility-frequency half-cycle of the grid voltage V_{grid}, the grid-connected reference current is negative, the pulse width of the high-frequency PWM driving signal of the switching transistors S₂/S₃ changes according to the sinusoidal pattern, and the switching transistors S₂/S₃ are driven consistently, while the switching transistors S₁/S₄ remain turned off. At this time, the current flows from the positive pole of the DC voltage input source to the negative pole of the grid Grid through the switching transistor S₃ and the filter inductor L₂, and then returns to the negative pole of the DC voltage input source through the positive pole of the grid Grid, the filter inductor L₁ and the switching transistor S₂.

In the embodiment of the present application, the waveform data of the output capacitor voltage across the switching transistor operating at high frequency and the corresponding filter inductor current refers to the first waveform data of the output capacitor voltages V_{C1/}V_{C4} of the output capacitors C₁/C₄ and the filter inductor current i_{L1} of the filter inductor L₁ during the high-frequency operation of the switching transistors S₁/S₄, or the second waveform data of the output capacitor voltages V_{C2}/V_{C3} of the output capacitors C₂/C₃ and the filter inductor current i_{L2} of the filter inductor L₂ during the high-frequency operation of the switching transistors S₂/S₃. Due to the symmetry of the grid-connected inverter, the waveform structures of the first waveform data and the second waveform data are the same. When determining the calculation rule of the switching period Tₛ meeting the zero-voltage switching condition, any set of waveform data in a switching period may be selected for analysis.

Specifically, firstly, based on a selected set of waveform data, the start/end time point of the switching period Tₛ meeting the zero-voltage switching condition is determined; then according to the start/end time point of the switching period Tₛ, each of stages included in the switching period Tₛ and the calculation rule of each of the stages are determined; and finally, the calculation rule of the switching period Tₛ is obtained according to the calculation rule of each of the stages. In FIG. 2, a body diode and an output capacitor are connected in parallel with each of the switching transistors of the grid-connected inverter. The output capacitor voltage is the same as the drain-source voltage across the corresponding switching transistor. That is, when the output capacitor voltage is zero, the drain-source voltage across the corresponding switching transistor is also zero. Therefore, the time point where the filter inductor current and the output capacitor voltage are both zero in the waveform data is the start/end time point of the switching period Tₛ meeting the zero-voltage switching condition.

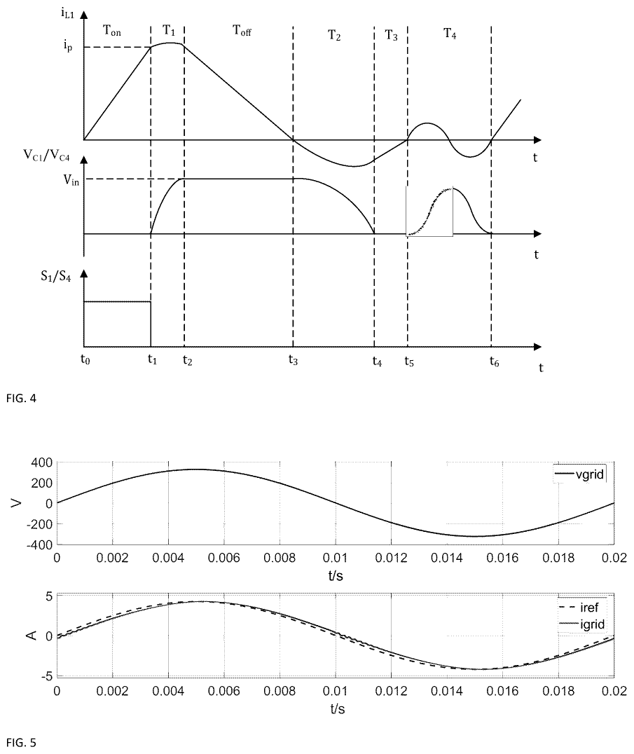

Referring to FIG. 4, there is shown a schematic view of the waveforms of the switching transistor S₁/S₄ driving, the output capacitor voltages V_{C1}/V_{C4} and the first filter inductor current i_{L1} for the grid voltage V_{grid} of the grid-connected inverter in FIG. 2 in a positive utility-frequency half-cycle. In the positive utility-frequency half-cycle, the grid-connected reference current is positive, the switching transistor S₁/S₄ operates at high frequency, and the switching transistor S₂/S₃ remains turned off. Before flowing into the grid, the grid-connected current passes through the filter inductor L₁ to generate the first filter inductor current i_{L1}. As can be seen from FIG. 4, a switching period may include the following six stages in the positive utility-frequency half-cycle:

### (1) Switching Transistor On-Stage Tₒₙ

The switching transistor on-stage Tₒₙ starts at time t₀ and ends at time t₁. Specifically, at the time to, the switching transistors S₁/S₄ are turned on, and the first filter inductor current i_{L1} linearly increases from zero; and at the time t₁, S/S₄ are turned off, and i_{L1} increases to the current peak iₚ. Because the switching transistors S₁/S₄ are continuously in the on state, the output capacitor voltages V_{C1}=V_{C4}=0.

### (2) Output Capacitor Charging Stage T₁

The output capacitor charging stage T₁ starts at time t₁ and end at time t₂. Specifically, at the time t₁, i_{L1} charges the output capacitors C₁/C₄ of S₁/S₄, and V_{C1}/V_{C4} rise from zero; and at the time t₂, V_{C1}=V_{C4}=Vᵢₙ. Within the stage T₁, i_{L1} remains approximately constant at iₚ.

### (3) Switching Transistor Off-Stage T_{off}

The switching transistor off-stage T_{off} starts at time t₂ and ends at time t₃. Specifically, at the time t₂, i_{L1} decreases linearly from iₚ, and at the time t₃, i_{L1} decreases to zero. Within the stage T_{off}, V_{C1}/V_{C4} remains constant at Vᵢₙ.

### (4) First Resonance Stage T₂

The first resonance stage T₂ starts at time t₃ and ends at time t₄. Specifically, at the time t₃, the inverter enters the first resonance stage, L₁, C1 and C4 form a resonance network, and i_{L1} is reversed and discharges C₁/C₄. At the time t₄, the voltage across C₁/C₄ is completely discharged to zero, i.e., V_{C1}=V_{C4}=0.

### (5) Body Diode Clamping Stage T₃

The body diode clamping stage T₃ starts at time t₄ and ends at time t₅. Specifically, at the time t₄, i_{L1} freewheels through the body diodes D₁/D₄, and V_{C1}/V_{C4} are clamped to zero by D₁/D₄, i.e., V_{C1}=V_{C4}=0, and at the time t₅, i_{L1} linearly rises to zero.

### (6) Second Resonance Stage T₄

The second resonance stage T₄ starts at time tₛ and ends at time t₆. Specifically, at the time t₅, the inverter enters the second resonance stage, and the amplitude of i_{L1} and V_{C1}/V_{C4} changes sinusoidally with the resonance period. At the time t₆, both i_{L1} and V_{C1}/V_{C4} resonate to zero, and at this time, the zero-voltage switching of the switching transistor can be realized. At this point, without external intervention, i_{L1} and V_{C1}/V_{C4} will keep cycling in the second resonance stage.

As can be known from the above-mentioned stages included in a switching period for the grid-connected inverter, the time when the output capacitor voltage V_{C1}/V_{C4} and the filter inductor current i_{L1} are both zero is the time corresponding to t₅+nT₄. n is the adjustment value of the switching period Tₛ and is an integer greater than or equal to zero. At all of these time points, zero-voltage switching of S₁/S₄ can be realized. Therefore, the switching period meeting the zero-voltage switching condition is Tₛ=Tₒₙ+T_{off}+T₁+T₂+T₃+nT₄. Obviously, the minimum switching period Tₛ is Tₒₙ+T_{off}+T₁+T₂+T₃. If the switching period is to be increased, then an appropriate value of n may be set according to the actual needs.

As can be known from FIG. 4, within the whole switching period Tₛ, V_{C1} and V_{C4} always remain equal. The capacitance value C₁/C₄ of the output capacitor of the switching transistor changes with the voltage V_{C1}/V_{C4} across the capacitor. That is, in each switching period, the capacitance value C of the output capacitor corresponding to the switching transistor in the on state is a function of the voltage V_{C} of the output capacitor, i.e., C=f₁(V_{c}). Therefore, the second resonance stage T₄ may be expressed as:

$${T}_{4} = 2 π \sqrt{2 {Lf}_{1} ( {V}_{c} )} ) \qquad ( 1 )$$

While in the second resonance stage T₄, V_{C1} and V_{C4} are positively correlated with the pressure difference Vᵢₙ−V_{grid}, which may be expressed as:

$${V}_{C 1} = {V}_{C 4} = {f}_{2} ( {V}_{in} - {V}_{grid} ) \qquad ( 2 )$$

Further speaking, the equation (1) may be further expressed as:

$${τ}_{4} = 2 π \sqrt{2 {Lf}_{3} ( {V}_{in} - {V}_{grid} )} \qquad ( 3 )$$

C is a function of pressure difference Vᵢₙ−V_{grid}. When T₄ is known, C can be uniquely determined. Therefore, the mapping relationship C=f₃(Vᵢₙ−V_{grid}) between the output capacitance C and the voltage difference between the DC input voltage Vᵢₙ and the grid voltage V_{grid} can be determined by the following operations:
firstly, based on multiple sets of waveform data of the output capacitor voltage (e.g., V_{C1}/V_{C4}) across the switching transistor operating at high frequency and the corresponding filter inductor current in different switching periods, measuring T₄ under conditions of different DC input voltages Vᵢₙ and different grid voltages V_{grid}, and calculating the capacitance value C of the corresponding output capacitor according to the measured T₄ by using the equation (3);
secondly, by taking the difference (Vᵢₙ−V_{grid}) between the different DC input voltages Vᵢₙ and the different grid voltages V_{grid} as input and taking the capacitance value C of the output capacitor calculated according to the different DC input voltages Vᵢₙ and the different grid voltages V_{grid} as output, obtaining the mapping relationship C=f₃(Vᵢₙ−V_{grid}) between the capacitance value C of the output capacitor and the voltage difference between the DC input voltage Vᵢₙ and the grid voltage V_{grid} by polynomial fitting. This mapping relationship is not only suitable for the differences of switching transistor devices from different manufacturers, but also considers the working condition that the capacitance of the output capacitor of the same switching transistor changes dynamically with the voltage across the capacitor.

Further speaking, according to the mapping relationship and based on Kirchhoff's voltage and current law, the calculation rules of the switching transistor on-stage Tₒₙ, the output capacitor charging stage T₁, the switching transistor off-stage T_{off}, the first resonance stage T₂, and the body diode clamping stage T₃ can be obtained specifically as follow:

$${T}_{on} = \frac{2 {Li}_{p}}{{V}_{in} - \vert {V}_{grid} \vert} \qquad ( 4 )$$

$${T}_{off} = \frac{2 {Li}_{p}}{{V}_{in} + \vert {V}_{grid} \vert} \qquad ( 5 )$$

$${T}_{1} = \frac{2 LC}{2 \vert {i}_{ref} \vert + \sqrt{\frac{C}{2 L} ( {V}_{in} + \vert {V}_{grid} \vert )}} \qquad ( 6 )$$

$${T}_{2} = \sqrt{2 LC} arccos ( \frac{\vert {V}_{grid} \vert - {V}_{in}}{\vert {V}_{grid} \vert + {V}_{in}} ) \qquad ( 7 )$$

$${T}_{3} = \sqrt{2 LC} ( \frac{{V}_{in} + \vert {V}_{grid} \vert}{{V}_{in} - \vert {V}_{grid} \vert} ) sin ( \frac{{T}_{2}}{\sqrt{2 LC}} ) \qquad ( 8 )$$

iₚ is the peak value of the filter inductor current. Within the switching period Tₛ, there is the following relationship between it and the duty ratio duty:

$${i}_{p} = \frac{duty \times ( {T}_{1} + {T}_{2} + {T}_{3} + {nT}_{4} ) ( {V}_{in}^{2} - {V}_{grid}^{2} )}{2 L ( {V}_{in} + \vert {V}_{grid} \vert - 2 duty {V}_{in} )} \qquad ( 9 )$$

So far, the calculation rules of each of the stages (i.e., Tₒₙ, T_{off}, T₁, T₂, T₃, T₄) included in the switching period Tₛ within the positive utility-frequency half-cycle and the mapping relationship C=f₃(Vᵢₙ−V_{grid}) have been determined. As shall be appreciated, the calculation rule of the switching period in the negative utility-frequency half-cycle is the same as that in the positive utility-frequency half-cycle. The difference is that the grid voltage V_{grid} and the grid-connected reference current i_{ref} are negative in the negative utility-frequency half-cycle. Therefore, in order to unify the calculation, the absolute values of both the grid voltage V_{grid} and the grid-connected reference current i_{ref} are taken in the calculation rule of the switching period Tₛ.

Step S102, acquiring the DC input voltage, the grid voltage, the grid-connected current and the grid-connected reference current.

In the embodiment of the present application, the grid-connected inverter further comprises DC voltage sampling units, grid voltage sampling units and a grid-connected current sampling unit. The DC voltage sampling units are arranged at both sides of the DC voltage input source for collecting the DC input voltage in real time. The grid voltage sampling units are arranged at both sides of the grid voltage for collecting the grid voltage in real time. The grid-connected current sampling unit is arranged at the current output side of the inverter for collecting the grid-connected current in real time. In each switching period, the controller of the grid-connected inverter acquires the DC input voltage, the grid voltage and the grid-connected current in real time through the DC voltage sampling units, the grid voltage sampling units and the grid-connected current sampling unit.

The grid-connected reference current is a set value, and the waveform of the grid-connected reference current changes sinusoidally in a utility frequency period. The equation for the calculation of grid-connected reference current is:

$${i}_{ref} = {I}_{ref} sin ( ω t ) \qquad ( 10 )$$

wherein I_{ref} is the amplitude of the grid-connected reference current, and cot is the phase of the grid-connected reference current.

Step S103, according to the polarity of the grid-connected reference current, determining the switching transistor operating at high frequency.

For the grid-connected inverter shown in FIG. 2, when the grid-connected reference current is positive, the switching transistors S₁/S₄ are controlled to operate at high frequency; and when the grid-connected reference current is negative, the switching transistors S₂/S₃ are controlled to operate at high frequency.

Step S104, according to the grid-connected current and the grid-connected reference current, determining the duty ratio based on a closed-loop regulation mechanism.

In the embodiment of the present application, the closed-loop controller of the grid-connected current may be a Proportion Integration (PI) controller, a Proportional Integration Differentiation (PID) controller, and the like. The equation for the calculation of the duty ratio duty is:

$$duty = {G}_{P} ( {i}_{ref} - {i}_{grid} ) \qquad ( 11 )$$

wherein G_{P} is the transfer function of the closed-loop controller.

Step S105: determining the switching period Tₛ according to the calculation rule of the switching period Tₛ, the mapping relationship, the DC input voltage, the grid voltage, the grid-connected reference current and the duty ratio.

In the embodiment of the present application, the calculation rule of the switching period Tₛ meeting the zero-voltage switching condition and the mapping relationship between the capacitance value of the output capacitor and the voltage difference between the DC input voltage and the grid voltage, after being determined, are fixed in the controller of the grid-connected inverter. In each switching period, the controller acquires various parameter information required by the calculation rule, and brings the various parameter information into the calculation rule of the switching period, so that the duration of each switching period can be calculated. As can be known from the calculation rule of the switching period Tₛ obtained above, the parameter information includes the DC input voltage, the grid voltage, the grid-connected reference current and the duty ratio or the like.

Step S106, controlling the zero-voltage switching of the switching transistor according to the switching period Tₛ and the duty ratio.

As shall be appreciated, after the calculation rule of the switching period Tₛ meeting the zero-voltage switching condition and the mapping relationship between the capacitance value of the output capacitor and the voltage difference between the DC input voltage and the grid voltage are fixed into the controller, the controller only needs to execute steps S102 to S106 in each switching period.

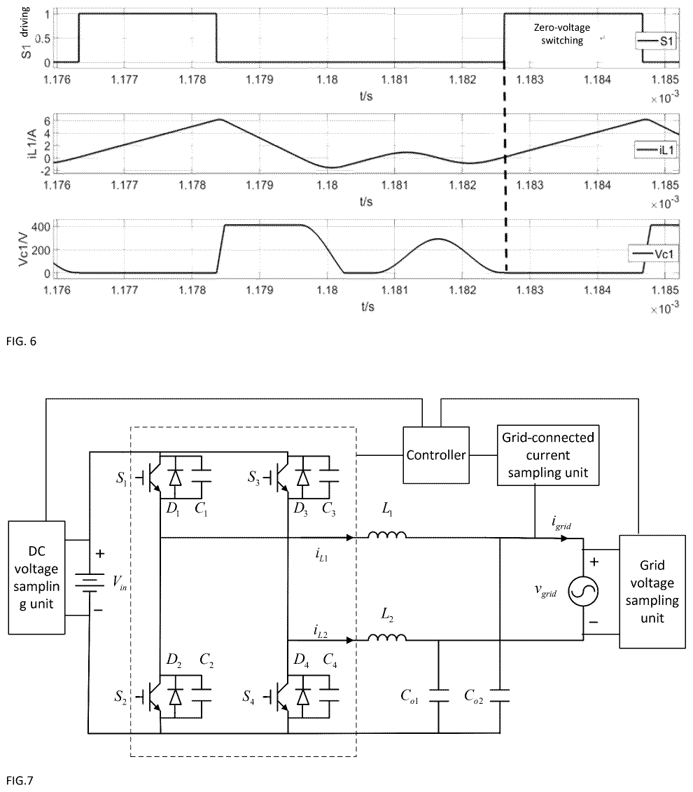

Referring to FIG. 5 and FIG. 6, FIG. 5 is a simulation result diagram of grid-connected current using the grid-connected inverter control method of FIG. 1; and FIG. 6 is a simulation control effect diagram using the grid-connected inverter control method of FIG. 1. As can be seen from FIG. 5 and FIG. 6, the grid-connected inverter control method of the present application ensures the synchronization of the grid-connected current and the grid-connected reference current while realizing the zero-voltage switching of the switching transistor.

For the grid-connected inverter control method provided according to the embodiments of the present application, firstly, based on the waveform data of the output capacitor voltage across the switching transistor operating at high frequency and the corresponding filter inductor current, the calculation rule of the switching period Tₛ meeting the zero-voltage switching condition and the mapping relationship between the capacitance value of the output capacitor and the voltage difference between the DC input voltage and the grid voltage are determined; then, the DC input voltage, the grid voltage, the grid-connected current and the grid-connected reference current are acquired, the switching transistor operating at high frequency is determined according to the polarity of the grid-connected reference current, and the duty ratio is determined based on a closed-loop regulation mechanism according to the grid-connected current and the grid-connected reference current; and finally, the switching period Tₛ is calculated according to the calculation rule of the switching period Tₛ, the mapping relationship, the DC input voltage, the grid voltage, the grid-connected reference current and the duty ratio, and the zero-voltage switching of the switching transistor operating at high frequency is controlled according to the switching period Tₛ and the duty ratio. By adopting the method of the present application, zero-voltage switching of the switching transistor is realized, which effectively reduces the loss caused by the turn-on process of the switching transistor.

### Embodiment 2

According to an embodiment of the present application, a grid-connected inverter is provided. As shown in FIG. 7, which is a schematic structural diagram of a grid-connected inverter provided according to an embodiment of the present application, the grid-connected inverter comprises a DC voltage input source, switching transistors S₁ to S₄, and body diodes D₁ to D₄ and output capacitors C₁ to C₄ connected in parallel with the switching transistors, a filter inductor L₁ and a filter capacitor Cₒ₂ connected to the bridge arm where the switching transistor S₁/S₂ is located, a filter inductor L₂ and a filter capacitor Cₒ₁ connected to the bridge arm where the switching transistor S₃/S₄ is located, a grid Grid, and a controller, wherein the calculation rule of the switching period Tₛ meeting the zero-voltage switching condition and the mapping relationship between the capacitance value of the output capacitor and the voltage difference between the DC input voltage and the grid voltage are preset in the controller.

Specifically, the controller is configured to acquire the DC input voltage, the grid voltage, a grid-connected current and a grid-connected reference current; determine the switching transistor operating at high frequency according to the polarity of the grid-connected reference current; determine the duty ratio based on a closed-loop regulation mechanism according to the grid-connected current and the grid-connected reference current; determine the switching period Tₛ according to the calculation rule of the switching period Tₛ, the mapping relationship, the DC input voltage, the grid voltage, the grid-connected reference current and the duty ratio; and control the zero-voltage switching of the switching transistor according to the switching period Tₛ and the duty ratio.

In the embodiment of the present application, the grid-connected inverter further comprises DC voltage sampling units, grid voltage sampling units and a grid-connected current sampling unit. The DC voltage sampling units are arranged at both sides of the DC voltage input source for collecting the DC input voltage in real time. The grid voltage sampling units are arranged at both sides of the grid voltage for collecting the grid voltage in real time. The grid-connected current sampling unit is arranged at the current output side of the inverter for collecting the grid-connected current in real time. In each switching period, the controller acquires the DC input voltage, the grid voltage and the grid-connected current in real time through the DC voltage sampling units, the grid voltage sampling units and the grid-connected current sampling unit.

In the embodiment of the present application, based on a set of waveform data of the output capacitor voltage across the switching transistor operating at high frequency and the corresponding filter inductor current in a switching period, the start/end time point of the switching period Tₛ meeting the zero-voltage switching condition can be determined; then based on the time point, each of stages included in the switching period Tₛ and the calculation rule of each of the stages are determined, and the calculation rule of the switching period Tₛ is obtained according to the calculation rule of each of the stages. Specifically, the switching period Tₛ comprises a switching transistor on-stage Tₒₙ, an output capacitor charging stage T₁, a switching transistor off-stage T_{off}, a first resonance stage T₂, a body diode clamping stage T₃ and several second resonance stages T₄. That is, Tₛ=Tₒₙ+T_{off}+T₁+T₂+T₃+nT₄, wherein n is an integer greater than or equal to 0.

In the embodiment of the present application, the calculation rule of the switching period Tₛ is specifically as follows:

$$\{ \begin{matrix}{T}_{s} & = {T}_{on} + {T}_{off} + {T}_{1} + {T}_{2} + {T}_{3} + {nT}_{4} \\ {T}_{on} & = \frac{2 {Li}_{p}}{{V}_{in} - \vert {V}_{grid} \vert} \\ {T}_{off} & = \frac{2 {Li}_{p}}{{V}_{in} + \vert {V}_{grid} \vert} \\ {T}_{1} & = \frac{2 LC}{2 \vert {i}_{ref} \vert + \sqrt{\frac{C}{2 L} ( {V}_{in} + \vert {V}_{grid} \vert )}} \\ {T}_{2} & = \sqrt{2 LC} arccos ( \frac{\vert {V}_{grid} \vert - {V}_{in}}{\vert {V}_{grid} \vert + {V}_{in}} ) \\ {T}_{3} & = \sqrt{2 LC} ( \frac{{V}_{in} + \vert {V}_{grid} \vert}{{V}_{in} - \vert {V}_{grid} \vert} ) sin ( \frac{{T}_{2}}{\sqrt{2 LC}} ) \\ {T}_{4} & = 2 π \sqrt{2 LC}\end{matrix}$$

wherein n is the adjustment value of the switching period Tₛ and is an integer greater than or equal to zero, L is the inductance value of the filter inductor,

$${i}_{p} = \frac{duty \times ( {T}_{1} + {T}_{2} + {T}_{3} + {nT}_{4} ) ( {V}_{in}^{2} - {V}_{grid}^{2} )}{2 L ( {V}_{in} + \vert {V}_{grid} \vert - 2 duty {V}_{in} )} ,$$

iₚ is the peak value of the filter inductor current, duty is the duty ratio, Vᵢₙ is the DC input voltage, V_{grid} is the grid voltage, i_{ref} is the grid-connected reference current, and C is the capacitance value of the output capacitor, which has a mapping relationship expressed as C=f₃(Vᵢₙ−V_{grid}) with the voltage difference Vᵢₙ−V_{grid}.

As can be seen from the above calculation equation, when T₄ is known, C can be uniquely determined. Therefore, the mapping relationship C=f₃(Vᵢₙ−V_{grid}) between the output capacitance C and the voltage difference between the DC input voltage Vᵢₙ and the grid voltage V_{grid} can be determined by the following operations:
firstly, based on multiple sets of waveform data of the output capacitor voltage (e.g., V_{C1}/V_{C4}) across the switching transistor operating at high frequency and the corresponding filter inductor current in different switching periods, measuring T₄ under conditions of different DC input voltages Vᵢₙ and different grid voltages V_{grid}, and calculating the capacitance value C of the corresponding output capacitor according to the measured T₄ by using the equation (3);
secondly, by taking the difference (Vᵢₙ−V_{grid}) between the different DC input voltages Vᵢₙ and the different grid voltages V_{grid} as input and taking the capacitance value C of the output capacitor calculated according to the different DC input voltages Vᵢₙ and the different grid voltages V_{grid} as output, obtaining the mapping relationship C=f₃(Vᵢₙ−V_{grid}) between the capacitance value C of the output capacitor and the voltage difference between the DC input voltage Vᵢₙ and the grid voltage V_{grid} by polynomial fitting.

Finally it shall be noted that, the above embodiments are only used to describe but not to limit the technical solutions of this application; and within the spirits of this application, technical features of the above embodiments or different embodiments may also be combined with each other, the steps may be implemented in an arbitrary order, and many other variations in different aspects of this application described above are possible although, for purpose of simplicity, they are not provided in the details. Although this application has been detailed with reference to the above embodiments, those of ordinary skill in the art shall appreciate that modifications can still be made to the technical solutions disclosed in the above embodiments or equivalent substations may be made to some of the technical features, and the corresponding technical solutions will not essentially depart from the scope of the embodiments of this application due to such modifications or substations.

1. A grid-connected inverter control method, the method comprising:
Step A, based on the waveform data of an output capacitor voltage across a switching transistor operating at high frequency and the corresponding filter inductor current, determining a calculation rule of the switching period Tₛ meeting the zero-voltage switching condition and a mapping relationship between the capacitance value of the output capacitor and a voltage difference between a DC input voltage and a grid voltage;
Step B, acquiring the DC input voltage, the grid voltage, a grid-connected current and a grid-connected reference current;
Step C, according to the polarity of the grid-connected reference current, determining the switching transistor operating at high frequency;
Step D, according to the grid-connected current and the grid-connected reference current, determining the duty ratio based on a closed-loop regulation mechanism;
Step E, calculating the switching period Tₛ according to the calculation rule of the switching period Tₛ, the mapping relationship, the DC input voltage, the grid voltage, the grid-connected reference current and the duty ratio; and
Step F, controlling the zero-voltage switching of the switching transistor according to the switching period Tₛ and the duty ratio.

2. The method according to claim 1, wherein, the Step A comprises:
based on a set of waveform data of the output capacitor voltage across the switching transistor operating at high frequency and the corresponding filter inductor current in a switching period, determining the start/end time point of the switching period Tₛ meeting the zero-voltage switching condition;
according to the start/end time point of the switching period Tₛ, determining each of stages included in the switching period Tₛ and the calculation rule of each of the stages; and
obtaining the calculation rule of the switching period Tₛ according to the calculation rule of each of the stages.

3. The method according to claim 2, wherein, the start/end time point of the switching period Tₛ meeting the zero-voltage switching condition is the time point when the filter inductor current and the output capacitor voltage are both zero in the set of waveform data.

4. The method according to claim 2, wherein, the switching period Tₛ comprises a switching transistor on-stage Tₒₙ, an output capacitor charging stage T₁, a switching transistor off-stage T_{off}, a first resonance stage T₂, a body diode clamping stage T₃ and several second resonance stages T₄.

5. The method according to claim 4, wherein, the calculation rule of the switching period Tₛ is:
$$\{ \begin{matrix}{T}_{s} & = {T}_{on} + {T}_{off} + {T}_{1} + {T}_{2} + {T}_{3} + {nT}_{4} \\ {T}_{on} & = \frac{2 {Li}_{p}}{{V}_{in} - \vert {V}_{grid} \vert} \\ {T}_{off} & = \frac{2 {Li}_{p}}{{V}_{in} + \vert {V}_{grid} \vert} \\ {T}_{1} & = \frac{2 LC}{2 \vert {i}_{ref} \vert + \sqrt{\frac{C}{2 L} ( {V}_{in} + \vert {V}_{grid} \vert )}} \\ {T}_{2} & = \sqrt{2 LC} arccos ( \frac{\vert {V}_{grid} \vert - {V}_{in}}{\vert {V}_{grid} \vert + {V}_{in}} ) \\ {T}_{3} & = \sqrt{2 LC} ( \frac{{V}_{in} + \vert {V}_{grid} \vert}{{V}_{in} - \vert {V}_{grid} \vert} ) sin ( \frac{{T}_{2}}{\sqrt{2 LC}} ) \\ {T}_{4} & = 2 π \sqrt{2 LC}\end{matrix}$$
wherein, n is the adjustment value of the switching period Tₛ and is an integer greater than or equal to zero, L is the inductance value of the filter inductor,
$${i}_{p} = \frac{duty \times ( {T}_{1} + {T}_{2} + {T}_{3} + {nT}_{4} ) ( {V}_{in}^{2} - {V}_{grid}^{2} )}{2 L ( {V}_{in} + \vert {V}_{grid} \vert - 2 duty {V}_{in} )} ,$$
iₚ is the peak value of the filter inductor current, duty is the duty ratio, Vᵢₙ is the DC input voltage, V_{grid} is the grid voltage, i_{ref} is the grid-connected reference current, and C is the capacitance value of the output capacitor, which has a mapping relationship expressed as C=f₃(Vᵢₙ−V_{grid}) with the voltage difference Vᵢₙ−V_{grid}.

6. The method according to claim 5, wherein, the Step A further comprises:
based on multiple sets of waveform data of the output capacitor voltage across the switching transistor operating at high frequency and the corresponding filter inductor current in different switching periods, measuring the second resonance stages T₄ under conditions of different DC input voltages Vᵢₙ and different grid voltages V_{grid}, and calculating the capacitance value C of the corresponding output capacitor according to the measured the second resonance stages T₄;
by taking the difference (Vᵢₙ−V_{grid}) between the different DC input voltages Vᵢₙ and the different grid voltages V_{grid} as input and taking the capacitance value C of the output capacitor calculated according to the different DC input voltages Vᵢₙ and the different grid voltages V_{grid} as output, obtaining the mapping relationship C=f₃(Vᵢₙ−V_{grid}) between the capacitance value C of the output capacitor and the voltage difference between the DC input voltage Vᵢₙ and the grid voltage V_{grid} by polynomial fitting.

7. The method according to claim 5, wherein, the step D comprises:
according to the grid-connected current i_{grid} and the grid-connected reference current i_{ref}, calculating the duty ratio duty based on the following equation:
$$duty = {G}_{P} ( {i}_{ref} - {i}_{grid} )$$
wherein G_{P} is the transfer function of a closed-loop controller.

8. A grid-connected inverter, comprising a controller, wherein a calculation rule of the switching period Tₛ meeting the zero-voltage switching condition and a mapping relationship between the capacitance value of the output capacitor and a voltage difference between a DC input voltage and a grid voltage are preset in the controller,
the controller is configured to acquire the DC input voltage, the grid voltage, a grid-connected current and a grid-connected reference current; determine the switching transistor operating at high frequency according to the polarity of the grid-connected reference current; determine the duty ratio based on a closed-loop regulation mechanism according to the grid-connected current and the grid-connected reference current; determine the switching period Tₛ according to the calculation rule of the switching period Tₛ, the mapping relationship, the DC input voltage, the grid voltage, the grid-connected reference current and the duty ratio; and control the zero-voltage switching of the switching transistor according to the switching period Tₛ and the duty ratio.

9. The grid-connected inverter according to claim 8, wherein, the calculation rule of the switching period Tₛ is determined based on a following method:
based on a set of waveform data of the output capacitor voltage across the switching transistor operating at high frequency and the corresponding filter inductor current in a switching period, determining the start/end time point of the switching period Tₛ meeting the zero-voltage switching condition;
according to the start/end time point of the switching period Tₛ, determining each of stages included in the switching period Tₛ and the calculation rule of each of the stages; and
obtaining the calculation rule of the switching period Tₛ according to the calculation rule of each of the stages.

10. The grid-connected inverter according to claim 9, wherein, the start/end time point of the switching period Tₛ meeting the zero-voltage switching condition is the time point when the filter inductor current and the output capacitor voltage are both zero in the set of waveform data.

11. The grid-connected inverter according to claim 9, wherein, the switching period Tₛ comprises a switching transistor on-stage Tₒₙ, an output capacitor charging stage T₁, a switching transistor off-stage T_{off}, a first resonance stage T₂, a body diode clamping stage T₃ and several second resonance stages T₄.

12. The grid-connected inverter according to claim 11, wherein, the calculation rule of the switching period Tₛ is:
$$\{ \begin{matrix}{T}_{s} & = {T}_{on} + {T}_{off} + {T}_{1} + {T}_{2} + {T}_{3} + {nT}_{4} \\ {T}_{on} & = \frac{2 {Li}_{p}}{{V}_{in} - \vert {V}_{grid} \vert} \\ {T}_{off} & = \frac{2 {Li}_{p}}{{V}_{in} + \vert {V}_{grid} \vert} \\ {T}_{1} & = \frac{2 LC}{2 \vert {i}_{ref} \vert + \sqrt{\frac{C}{2 L} ( {V}_{in} + \vert {V}_{grid} \vert )}} \\ {T}_{2} & = \sqrt{2 LC} arccos ( \frac{\vert {V}_{grid} \vert - {V}_{in}}{\vert {V}_{grid} \vert + {V}_{in}} ) \\ {T}_{3} & = \sqrt{2 LC} ( \frac{{V}_{in} + \vert {V}_{grid} \vert}{{V}_{in} - \vert {V}_{grid} \vert} ) sin ( \frac{{T}_{2}}{\sqrt{2 LC}} ) \\ {T}_{4} & = 2 π \sqrt{2 LC}\end{matrix}$$
wherein, n is the adjustment value of the switching period Tₛ and is an integer greater than or equal to zero, L is the inductance value of the filter inductor),
$${i}_{p} = \frac{duty \times ( {T}_{1} + {T}_{2} + {T}_{3} + {nT}_{4} ) ( {V}_{in}^{2} - {V}_{grid}^{2} )}{2 L ( {V}_{in} + \vert {V}_{grid} \vert - 2 duty {V}_{in} )} ,$$
iₚ is the peak value of the filter inductor current, duty is the duty ratio, Vᵢₙ is the DC input voltage, V_{grid} is the grid voltage, i_{ref} is the grid-connected reference current, and C is the capacitance value of the output capacitor, which has a mapping relationship expressed as C=f₃(Vᵢₙ−V_{grid}) with the voltage difference Vᵢₙ−V_{grid}.

13. The grid-connected inverter according to claim 9, wherein, the mapping relationship is determined based on a following method:
based on multiple sets of waveform data of the output capacitor voltage across the switching transistor operating at high frequency and the corresponding filter inductor current in different switching periods, measuring the second resonance stages T₄ under conditions of different DC input voltages Vᵢₙ and different grid voltages V_{grid}, and calculating the capacitance value C of the corresponding output capacitor according to the measured the second resonance stages T₄;
by taking the difference (Vᵢₙ−V_{grid}) between the different DC input voltages Vᵢₙ and the different grid voltages V_{grid} as input and taking the capacitance value C of the output capacitor calculated according to the different DC input voltages Vᵢₙ and the different grid voltages V_{grid} as output, obtaining the mapping relationship C=f₃(Vᵢₙ−V_{grid}) between the capacitance value C of the output capacitor and the voltage difference between the DC input voltage Vᵢₙ and the grid voltage V_{grid} by polynomial fitting.

14. The grid-connected inverter according to claim 12, wherein, the duty ratio is determined based on a following method:
according to the grid-connected current i_{grid} and the grid-connected reference current i_{ref}, calculating the duty ratio duty based on the following equation:
$$duty = {G}_{P} ( {i}_{ref} - {i}_{grid} )$$
